(19) United States
(12) Patent Application Publication
(10) Pub. No.: US 2026/0200762 A1
(43) Pub. Date: Jul. 16, 2026

(54) COUNTERCURRENT-COCURRENT DISSOLVED AIR FLOTATION PROCESS SYSTEM

(71) Applicant: Guangdong Ocean University, Zhanjiang (CN)

(72) Inventors: Ningxia Yin, Zhanjiang (CN); Qiaoxin Zheng, Zhanjiang (CN); Xingzhen Li, Zhanjiang (CN); Jingyu Zhu, Zhanjiang (CN); Zhitao Chen, Zhanjiang (CN); Jiaxing Hou, Zhanjiang (CN); Guangwei Cheng, Zhanjiang (CN)

(21) Appl. No.: 19/313,760

(22) Filed: Aug. 28, 2025

Related U.S. Application Data
(63) Continuation of application No. PCT/CN2025/105518, filed on Jun. 30, 2025.

(30) Foreign Application Priority Data
Jan. 10, 2025 (CN) 202411575443.3

(51) Int. Cl. C02F 1/24; C02F 1/52

(52) U.S. Cl. CPC C02F 1/24; C02F 1/5281; C02F 2201/005

(57) ABSTRACT

A countercurrent-cocurrent dissolved air flotation (CCDAF) process system includes a chemical dosing zone, a counter-current contact zone, a co-current contact zone, a separation zone, and a clarified effluent zone arranged in an air flotation tank body; a wastewater inlet and a chemical dosing port are arranged at a bottom of the chemical dosing zone, and a motorized valve is arranged on the chemical dosing port; and an agitator and a fluorescence sensor are arranged in the chemical dosing zone. A chemical dosage is automatically regulated to ensure homogeneous mixing of reagents. Bubble-floc complexes are filtered out during lateral movement of a moving trolley in both directions. Simultaneously, high-pressure water is sprayed onto surfaces of dissolved air releasers through high-pressure nozzles, preventing clogging of the dissolved air releasers.

### CROSS-REFERENCE TO RELATED APPLICATIONS

This application is a continuation of PCT/CN2025/105518, filed on June 30, 2025 and claims priority of Chinese Patent Application No. 202411575443.3, filed on January 10, 2025, the entire contents of which are incorporated herein by reference.

### TECHNICAL FIELD

The present disclosure relates to the field of wastewater treatment, and in particular to a countercurrent-cocurrent dissolved air flotation (CCDAF) process system.

### BACKGROUND

With the rapid development of global industry, the demand for petroleum has significantly increased. Consequently, refineries are generating a growing volume of oily wastewater. This oily wastewater exhibits characteristics such as high emulsification and low concentrations of contaminated oil and suspended solids, thereby increasing the complexity of treatment. Conventional treatment technologies fail to meet discharge standards. An air flotation method is widely adopted due to its advantages, including high treatment efficiency, reduced chemical dosage requirements, short retention time, and compact footprint. A principle of air flotation for oil removal operates as follows: the oily wastewater enters through a water inlet, and a solution of coagulants and flocculants is introduced via a chemical feed port. By rotating impellers, the reagents can achieve homogeneous mixing, facilitating agglomeration of small-diameter oil droplets and suspended solids (hereinafter referred to as flocs) into larger flocs. High-pressure dissolved air water is introduced into contact zones, where microbubbles are generated through low-pressure release via a dissolved air releaser. These microbubbles combine with coagulated and flocculated flocs, forming bubble-floc complexes with densities lower than water, thereby floating to the water surface. A chain-driven skimmer plate device operates, scraping the floated bubble-floc complexes into an oil storage groove. The treated oily wastewater is finally discharged through a water outlet.

For example, in the related art, a Chinese patent with publication number CN214611888U provides a horizontal air flotation device; a Chinese patent with publication number CN220845615U provides an air flotation scum and sludge scraper mechanism; a Chinese patent with publication number CN117843068A provides a high-efficiency dissolved-air flotation unit; a Chinese patent with publication number CN221071108U provides an improved air flotation unit; a Chinese patent with publication number CN117699897B provides an air flotation unit for wastewater treatment and an operating method therefor; and a United States patent US01075250B2 provides a water treatment process for removing suspended solids using an air flotation method.

In the above air flotation solutions, a chemical dosage cannot be dynamically adjusted based on real-time fluctuations in floc volume within the oily wastewater. The impellers fail to achieve homogeneous mixing of wastewater and reagents. The chain-driven skimmer device is susceptible to mechanical failures and lacks adjustable skimming depth control, resulting in only unidirectional skimming due to a single-sided oil storage groove. Additionally, the dissolved air releaser is prone to clogging.

### SUMMARY

Based on the above problems, an objective of the present disclosure is to provide a CCDAF process system, employing the following technical solutions.

The present disclosure provides a CCDAF process system, including an air flotation tank body, a chemical dosing zone, a counter-current contact zone, a co-current contact zone, a separation zone, and a clarified effluent zone are sequentially arranged in the air flotation tank body from left to right; and a top of the counter-current contact zone is communicated with the chemical dosing zone, a bottom of the counter-current contact zone is communicated with the co-current contact zone, a top of the separation zone is communicated with the co-current contact zone, and a bottom of the separation zone is communicated with the clarified effluent zone;

a wastewater inlet and a chemical dosing port are arranged at a bottom of the chemical dosing zone, and a motorized valve is arranged on the chemical dosing port; an agitator and a fluorescence sensor are arranged in the chemical dosing zone, the fluorescence sensor is electrically connected to a first controller, and the first controller controls opening and closing operations of the motorized valve;

a counter-current dissolved air releaser is arranged at the bottom of the counter-current contact zone, a co-current dissolved air releaser is arranged at a bottom of the co-current contact zone, the counter-current dissolved air releaser and the co-current dissolved air releaser are connected to a high-pressure dissolved air water device, high-pressure nozzles are arranged at upper portions of the counter-current dissolved air releaser and the co-current dissolved air releaser, and the high-pressure nozzles are connected to a first water supply pipeline;

a reciprocating moving device is arranged at an upper portion of the top of the separation zone, with a vertically movable skimmer plate device arranged on the reciprocating moving device; a left oil storage groove and a left pressure sensor are arranged at a left side of the top of the separation zone, and a right oil storage groove and a right pressure sensor are arranged at a right side of the top of the separation zone; the left pressure sensor and the right pressure sensor are electrically connected to a second controller, and the second controller regulates vertical movement of the skimmer plate device; and an inclined plate device is arranged at the bottom of the separation zone; and

a filter membrane device is arranged in the clarified effluent zone, and a clarified water outlet is connected to a top of the clarified effluent zone.

Preferably, the agitator includes a drive motor, a power output shaft of the drive motor is connected to a rotating shaft, a plurality of fixing rods are arranged along the rotating shaft, and rotatable impellers are arranged at distal ends of the fixing rods.

Preferably, protective guards are arranged at upper portions of the high-pressure nozzles.

Preferably, the clarified water outlet is connected to an automated discharge valve through a pipe.

Preferably, the high-pressure dissolved air water device includes a dissolved air vessel, the dissolved air vessel is connected to an air storage vessel through an air channel, the dissolved air vessel is connected to the clarified water outlet through a second water supply pipeline, a water supply pump is arranged on the second water supply pipeline, and the dissolved air vessel is connected to the counter-current dissolved air releaser and the co-current dissolved air releaser through a third water supply pipeline.

Preferably, a water inlet end of the first water supply pipeline is connected to the second water supply pipeline, and a junction point between the first water supply pipeline and the second water supply pipeline is located downstream of the water supply pump; and an overflow valve is arranged on the second water supply pipeline.

Preferably, the reciprocating moving device includes a guide rail mounted above the separation zone, a moving trolley is arranged on the guide rail, and limit switches are arranged at two ends of the guide rail.

Preferably, the skimmer plate device includes a telescopic drive member, the telescopic drive member is arranged on the moving trolley, and a movable end of the telescopic drive member is connected to a skimmer plate.

Preferably, the telescopic drive member is an air cylinder.

Compared to the related art, the present disclosure has the following beneficial effects.

In the present disclosure, a chemical dosage is automatically regulated to ensure homogeneous mixing of oily wastewater with a solution of coagulants and flocculants. Bubble-floc complexes are filtered out during lateral movement of the moving trolley in both directions. Simultaneously, high-pressure water is sprayed onto surfaces of the dissolved air releasers through the high-pressure nozzles, preventing clogging of the dissolved air releasers.

### BRIEF DESCRIPTION OF THE DRAWINGS

The present disclosure is further described below in combination with the accompanying drawings.

FIG. 1 is a schematic structural diagram of a CCDAF process system according to the present disclosure;

FIG. 2 is a front schematic structural diagram of an agitator according to the present disclosure;

FIG. 3 is a top schematic structural diagram of an impeller arrangement along a rotating shaft according to the present disclosure;

FIG. 4 is a front schematic structural diagram of a reciprocating moving device and a skimmer plate device according to the present disclosure; and

FIG. 5 is a top schematic structural diagram of the reciprocating moving device and the skimmer plate device according to the present disclosure.

Reference numerals and denotations thereof: 1-air flotation tank body; 101-chemical dosing zone; 102-counter-current contact zone; 103-co-current contact zone; 104-separation zone; 105-clarified effluent zone; 2-wastewater inlet; 3-chemical dosing port; 4-motorized valve; 5-agitator; 501-drive motor; 502-rotating shaft; 503-fixing rod; 504-impeller; 6-fluorescence sensor; 7-first controller; 8-counter-current dissolved air releaser; 9-co-current dissolved air releaser; 10-high-pressure dissolved air water device; 1001-dissolved air vessel; 1002-air channel; 1003-air storage vessel; 1004-second water supply pipeline; 1005-water supply pump; 11-high-pressure nozzle; 12-first water supply pipeline; 13-reciprocating moving device; 1301-guide rail; 1302-moving trolley; 1303-limit switch; 14-skimmer plate device; 1401-telescopic drive member; 1402-skimmer plate; 15-left oil storage groove; 16-left pressure sensor; 17-right oil storage groove; 18-right pressure sensor; 19-second controller; 20-inclined plate device; 21-filter membrane device; 22-clarified water outlet; 23-protective guard; 24-automated discharge valve; and 25-overflow valve.

### DETAILED DESCRIPTION

To clarify the technical problems, solutions, and benefits that the present disclosure aims to solve, the present disclosure is further described in detail in combination with the accompanying drawings and embodiments.

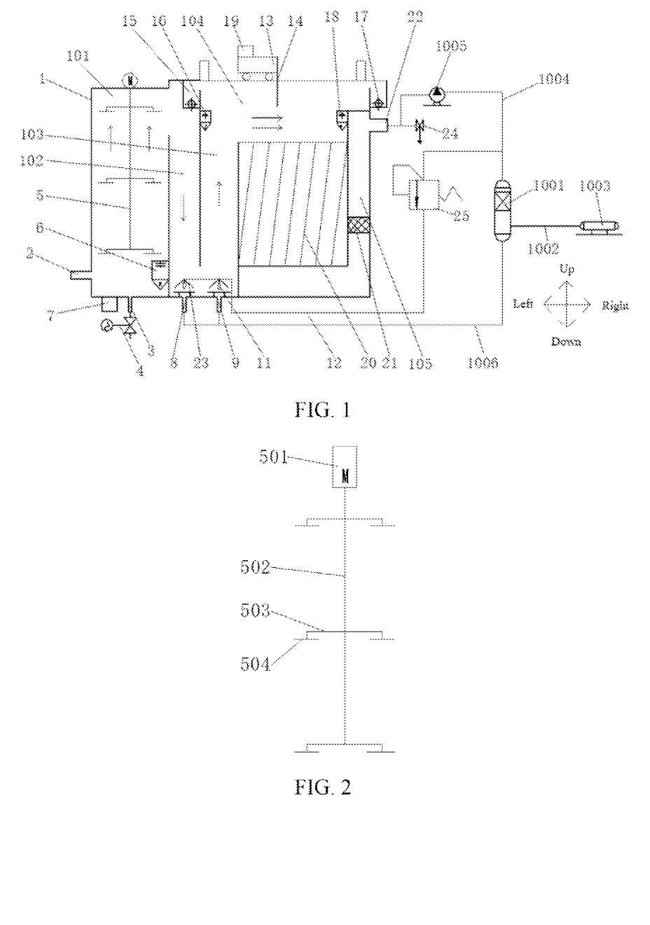

Referring to FIG. 1, an embodiment provides a CCDAF process system, including an air flotation tank body 1. Within the air flotation tank body 1, a plurality of baffle plates are arranged sequentially from left to right, partitioning inner space of the air flotation tank body 1 into a chemical dosing zone 101, a counter-current contact zone 102, a co-current contact zone 103, a separation zone 104, and a clarified effluent zone 105 sequentially from left to right; and a top of the counter-current contact zone 102 is communicated with the chemical dosing zone 101, a bottom of the counter-current contact zone 102 is communicated with the co-current contact zone 103, a top of the separation zone 104 is communicated with the co-current contact zone 103, and a bottom of the separation zone 104 is communicated with the clarified effluent zone 105.

A wastewater inlet 2 and a chemical dosing port 3 are arranged at a bottom of the chemical dosing zone 101, and a motorized valve 4 is arranged on the chemical dosing port 3; an agitator 5 and a fluorescence sensor 6 are arranged in the chemical dosing zone 101, the fluorescence sensor 6 is electrically connected to a first controller 7, and the first controller 7 controls opening and closing operations of the motorized valve 4. A counter-current dissolved air releaser 8 is arranged at the bottom of the counter-current contact zone 102, a co-current dissolved air releaser 9 is arranged at a bottom of the co-current contact zone 103, the counter-current dissolved air releaser 8 and the co-current dissolved air releaser 9 are connected to a high-pressure dissolved air water device 10, high-pressure nozzles 11 are arranged at upper portions of the counter-current dissolved air releaser 8 and the co-current dissolved air releaser 9, and the high-pressure nozzles 11 are connected to a first water supply pipeline 12. A reciprocating moving device 13 is arranged at an upper portion of the top of the separation zone 104, with a vertically movable skimmer plate device 14 arranged on the reciprocating moving device 13; a left oil storage groove 15 and a left pressure sensor 16 are arranged at a left side of the top of the separation zone 104, and a right oil storage groove 17 and a right pressure sensor 18 are arranged at a right side of the top of the separation zone 104; the left pressure sensor 16 and the right pressure sensor 18 are electrically connected to a second controller 19, and the second controller 19 regulates vertical movement of the skimmer plate device 14; and an inclined plate device 20 is arranged at the bottom of the separation zone 104. A filter membrane device 21 is arranged in the clarified effluent zone 105, a clarified water outlet 22 is connected to a top of the clarified effluent zone 105, and the clarified water outlet 22 is connected to an automated discharge valve 24 through a pipe.

In this embodiment, protective guards 23 are arranged at upper portions of the high-pressure nozzles 11.

In this embodiment, the high-pressure dissolved air water device 10 includes a dissolved air vessel 1001, the dissolved air vessel 1001 is connected to an air storage vessel 1003 through an air channel 1002, the dissolved air vessel 1001 is connected to the clarified water outlet 22 through a second water supply pipeline 1004, a water supply pump 1005 is arranged on the second water supply pipeline 1004, and the dissolved air vessel 1001 is connected to the counter-current dissolved air releaser 8 and the co-current dissolved air releaser 9 through a third water supply pipeline 1006.

In this embodiment, a water inlet end of the first water supply pipeline 12 is connected to the second water supply pipeline 1004, and a junction point between the first water supply pipeline 12 and the second water supply pipeline 1004 is located downstream of the water supply pump 1005; and an overflow valve 25 is arranged on the second water supply pipeline 1004.

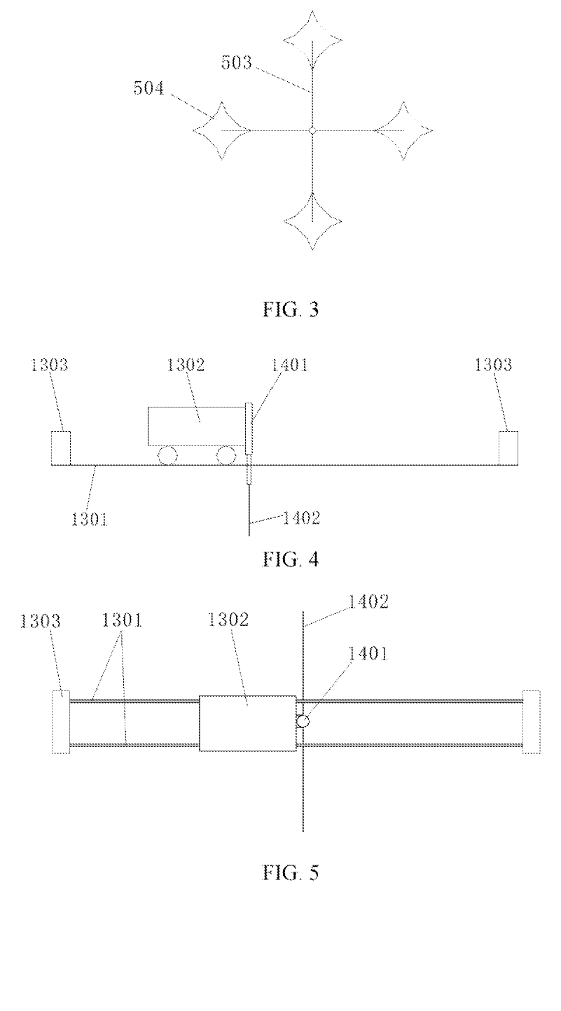

Referring to FIGS. 2-3, in this embodiment, the agitator 5 includes a drive motor 501, the drive motor 501 is mounted on the air flotation tank body 1, a power output shaft of the drive motor 501 is connected to a rotating shaft 502, a plurality of fixing rods 503 are arranged along the rotating shaft 502, and rotatable impellers 504 are arranged at distal ends of the fixing rods 503.

Referring to FIGS. 4-5, in this embodiment, the reciprocating moving device 13 includes a guide rail 1301 mounted above the separation zone 104, a moving trolley 1302 is arranged on the guide rail 1301, and limit switches 1303 are arranged at two ends of the guide rail 1301.

The skimmer plate device 14 includes a telescopic drive member 1401, the telescopic drive member 1401 is arranged on the moving trolley 1302, and a movable end of the telescopic drive member 1401 is connected to a skimmer plate 1402. Specifically, the telescopic drive member 1401 is an air cylinder.

Processing procedures of the present disclosure are as follows.

Oily wastewater enters the air flotation tank body 1 through the wastewater inlet 2, while the fluorescence sensor 6 detects flocs within the oily wastewater by measuring fluorescence signals emitted under ultraviolet excitation. The first controller 7 processes these fluorescence signals of different intensities, and sends signals to the motorized valve 4. An electric actuator within the motorized valve 4 is started, regulating the valve to an appropriate position. Simultaneously, a prepared solution of coagulants and flocculants is introduced into the air flotation tank body 1 through the chemical dosing port 3. The drive motor 501 of the agitator 5 rotates, driving the rotating shaft 502 to rotate. Furthermore, the fixing rods 503 drive the impellers 504 to rotate until homogeneous mixing of the oily wastewater and the prepared solution of coagulants and flocculants is achieved. Within this mixture, coagulation and flocculation reactions occur between small-diameter flocs and coagulants and flocculants, thereby forming enlarged flocs with significantly increased diameters.

Moreover, the flocs enter the counter-current contact zone 102 from the chemical dosing zone 101, and high-pressure dissolved air water is introduced into the counter-current dissolved air releaser 8 through the high-pressure dissolved air water device 10, entering the air flotation tank body 1. Since the air flotation tank body 1 is in a low-pressure state, microbubbles are released by the counter-current dissolved air releaser 8. Within the counter-current contact zone 102, these microbubbles collide with and adhere to the flocs, thereby forming bubble-floc complexes with densities below water. Under the impact of water flows, the partially adherent bubble-floc complexes and unattached flocs proceed from the bottom of the counter-current contact zone 102 into the co-current contact zone 103. Similarly, after the flocs enter the co-current contact zone 103, the high-pressure dissolved air water is introduced into the co-current dissolved air releaser 9 through the high-pressure dissolved air water device 10, entering the air flotation tank body 1. Since the air flotation tank body 1 is in a low-pressure state, microbubbles are released by the co-current dissolved air releaser 9. Within the co-current contact zone 103, these microbubbles collide with and adhere to the flocs, thereby forming bubble-floc complexes with densities below water. The partially adherent bubble-floc complexes and unattached flocs proceed from the top of the co-current contact zone 103 into the separation zone 104.

Within the counter-current contact zone 102 and the co-current contact zone 103, the microbubbles adhere to previously unattached flocs, forming bubble-floc complexes with densities below water. Therefore, these complexes float to the water surface. If the dissolved air releasers (specifically the counter-current dissolved air releaser 8 or co-current dissolved air releaser 9) become obstructed, pressure buildup occurs in the pipeline between the dissolved air releasers and the water supply pump 1005. Furthermore, the overflow valve 25 opens, directing the high-pressure water from the water supply pump 1005 into the high-pressure nozzles 11. The high-pressure water is ejected onto surfaces of the dissolved air releasers (the counter-current dissolved air releaser 8 or the co-current dissolved air releaser 9), thereby removing clogged floc deposits. The cleaning cycle persists until the clogged floc deposits are fully removed, at which point the pressure within the pipeline between the dissolved air releasers (the counter-current dissolved air releaser 8 or co-current dissolved air releaser 9) and the water supply pump 1005 normalizes to an operating range. Concurrently, the overflow valve 25 closes, and the high-pressure water from the water supply pump 1005 ceases to flow through the overflow valve 25 into the high-pressure nozzles 11.

Within an upper portion of the separation zone 104, there are aggregated bubble-floc complexes of a certain thickness. The left pressure sensor 16, upon detecting compressive force from the bubble-floc complexes, transmits a signal to the second controller 19. The second controller 19 processes this signal and controls the switching of the valve assembly, thereby regulating the operation of the telescopic drive member 1401. This telescopic drive member 1401 moves the skimmer plate 1402 downward to a certain distance. A motor mounted on the moving trolley 1302 drives the moving trolley 1302 to move along the guide rail 1301. The moving trolley 1302 stops its operation when it reaches the limit switch 1303 at a right end of the guide rail 1301. At the same time, the skimmer plate 1402 pushes the bubble-floc complexes into the right oil storage groove 17, thereby removing the bubble-floc complexes from the water. Similarly, the right pressure sensor 18, upon detecting compressive force from the bubble-floc complexes, transmits a signal to the second controller 19. The second controller 19 processes this signal and controls the switching of the valve assembly, thereby regulating the operation of the telescopic drive member 1401. This telescopic drive member 1401 moves the skimmer plate 1402 downward to a certain distance. The motor mounted on the moving trolley 1302 drives the moving trolley 1302 to move along the guide rail 1301. The moving trolley 1302 stops its operation when it reaches the limit switch 1303 at a left end of the guide rail 1301. At the same time, the skimmer plate 1402 pushes the bubble-floc complexes into the left oil storage groove 15, thereby removing the bubble-floc complexes from the water.

The water sample from this flotation process enters the inclined plate device 20. Leveraging a shallow tank principle, within the inclined plate device 20, the bubble-floc complexes float upward rapidly due to lower densities of the complexes than the water, while creating downward water flow. The complexes separated by the inclined plate device 20 are scraped off by the skimmer plate 1402. The water undergoing secondary filtration through the inclined plate device 20 flows into the clarified effluent zone 105. The filter membrane device 21 further intercepts residual bubble-floc complexes and unattached flocs at trace concentrations in the water, ensuring the final oily wastewater meets discharge standards, with clarified water exiting through the clarified water outlet 22.

The clarified water flowing out from the clarified water outlet 22 is split into two streams: one portion enters the water supply pump 1005, while another portion is discharged into the river through the automated discharge valve 24. After pressurization by the water supply pump 1005, water enters the dissolved air vessel 1001. Methane is introduced from the air storage vessel 1003 and dissolved in the pressurized water. Furthermore, the mixture is delivered via the third water supply pipeline 1006 to the counter-current dissolved air releaser 8 and the co-current dissolved air releaser 9. Microbubbles, released by these dissolved air releasers, combine with the flocs in the counter-current contact zone 102 and the co-current contact zone 103. According to the above process, the oily wastewater is treated cyclically.

It is to be noted that the first controller 7 and the second controller 19 may be controlled by a programmable logic controller (PLC).

The technical solutions of the present disclosure have the following advantages or positive effects.

(1) A chemical dosage is automatically controlled. The fluorescent sensor 6 detects the flocs within the oily wastewater by measuring the fluorescence signals emitted under ultraviolet excitation. The first controller 7 processes these fluorescence signals of different intensities, and sends signals to the motorized valve 4. The electric actuator within the motorized valve 4 is started, opening the valve to a predetermined position, allowing the precisely controlled dosages of coagulants and flocculants to enter the chemical dosing zone 101 through the chemical dosing port 3.

(2) The agitator 5 employs a multi-impeller configuration, ensuring gentle mixing intensity while achieving homogeneous mixing. The prepared solution of coagulants and flocculants is introduced into the chemical dosing zone 101 through the chemical dosing port 3. The drive motor 501 rotates, driving the rotating shaft 502 to rotate. Furthermore, the fixing rods 503 drive the small-diameter impellers 504 to rotate until homogeneous mixing of the oily wastewater and the prepared solution of coagulants and flocculants is achieved. Within this mixture, coagulation and flocculation reactions occur between small-diameter flocs and coagulants and flocculants, thereby forming enlarged flocs with significantly increased diameters.

(3) The moving trolley 1302 can achieve high efficiency in removing bubble-floc complexes during its reciprocating motion, with no idle stroke (the moving trolley 1302 always operates productively). Due to the presence of the left oil storage groove 15 and the right oil storage groove 17, the bubble-floc complexes are filtered out during lateral movement of the moving trolley 1302 in both directions. Moreover, the left pressure sensor 16 and the right pressure sensor 18 detect thickness variations of the bubble-floc complexes, and the telescopic drive member 1401 adjusts accordingly, positioning the skimmer plate 1402 at an appropriate height to scrape and filter the bubble-floc complexes.

(4) The microbubbles are continuously and stably infused, ensuring optimal contact and adhesion efficiency with flocs. Simultaneously, the dissolved air releasers exhibit high resistance to clogging. If the counter-current dissolved air releaser 8 or the co-current dissolved air releaser 9 becomes obstructed, pressure buildup occurs in the pipeline between the releasers and the water supply pump 1005. Furthermore, the overflow valve 25 opens, directing the high-pressure water from the water supply pump 1005 into the high-pressure nozzles 11. The high-pressure water is ejected onto the surfaces of the counter-current dissolved air releaser 8 or the co-current dissolved air releaser 9, thereby removing clogged floc deposits.

The foregoing embodiments are merely to describe preferred implementations of the present disclosure, rather than limiting the scope of the present disclosure. Without departing from the design spirit of the present disclosure, any modifications or improvements to the technical solutions of the present disclosure made by a person skilled in the art fall within the scope of protection defined by the claims of the present disclosure.

1. A countercurrent-cocurrent dissolved air flotation (CCDAF) process system, comprising an air flotation tank body (1), wherein a chemical dosing zone (101), a counter-current contact zone (102), a co-current contact zone (103), a separation zone (104), and a clarified effluent zone (105) are sequentially arranged in the air flotation tank body (1) from left to right; and a top of the counter-current contact zone (102) is communicated with the chemical dosing zone (101), a bottom of the counter-current contact zone (102) is communicated with the co-current contact zone (103), a top of the separation zone (104) is communicated with the co-current contact zone (103), and a bottom of the separation zone (104) is communicated with the clarified effluent zone (105);
a wastewater inlet (2) and a chemical dosing port (3) are arranged at a bottom of the chemical dosing zone (101), and a motorized valve (4) is arranged on the chemical dosing port (3); an agitator (5) and a fluorescence sensor (6) are arranged in the chemical dosing zone (101), the fluorescence sensor (6) is electrically connected to a first controller (7), and the first controller (7) controls opening and closing operations of the motorized valve (4);
a counter-current dissolved air releaser (8) is arranged at the bottom of the counter-current contact zone (102), a co-current dissolved air releaser (9) is arranged at a bottom of the co-current contact zone (103), the counter-current dissolved air releaser (8) and the co-current dissolved air releaser (9) are connected to a high-pressure dissolved air water device (10), high-pressure nozzles (11) are arranged at upper portions of the counter-current dissolved air releaser (8) and the co-current dissolved air releaser (9), and the high-pressure nozzles (11) are connected to a first water supply pipeline (12); and protective guards (23) are arranged at upper portions of the high-pressure nozzles (11), and high-pressure water is sprayed from the high-pressure nozzles (11) to surfaces of the dissolved air releasers;
a reciprocating moving device (13) is arranged at an upper portion of the top of the separation zone (104), with a vertically movable skimmer plate device (14) arranged on the reciprocating moving device (13); a left oil storage groove (15) and a left pressure sensor (16) are arranged at a left side of the top of the separation zone (104), and a right oil storage groove (17) and a right pressure sensor (18) are arranged at a right side of the top of the separation zone (104); the left pressure sensor (16) and the right pressure sensor (18) are electrically connected to a second controller (19), and the second controller (19) regulates vertical movement of the skimmer plate device (14); and an inclined plate device (20) is arranged at the bottom of the separation zone (104); and
a filter membrane device (21) is arranged in the clarified effluent zone (105), and a clarified water outlet (22) is connected to a top of the clarified effluent zone (105).

2. The CCDAF process system according to claim 1, wherein the agitator (5) comprises a drive motor (501), a power output shaft of the drive motor (501) is connected to a rotating shaft (502), a plurality of fixing rods (503) are arranged along the rotating shaft (502), and rotatable impellers (504) are arranged at distal ends of the fixing rods (503).

3. The CCDAF process system according to claim 1, wherein the clarified water outlet (22) is connected to an automated discharge valve (24) through a pipe.

4. The CCDAF process system according to claim 1, wherein the high-pressure dissolved air water device (10) comprises a dissolved air vessel (1001), the dissolved air vessel (1001) is connected to an air storage vessel (1003) through an air channel (1002), the dissolved air vessel (1001) is connected to the clarified water outlet (22) through a second water supply pipeline (1004), a water supply pump (1005) is arranged on the second water supply pipeline (1004), and the dissolved air vessel (1001) is connected to the counter-current dissolved air releaser (8) and the co-current dissolved air releaser (9) through a third water supply pipeline (1006).

5. The CCDAF process system according to claim 4, wherein a water inlet end of the first water supply pipeline (12) is connected to the second water supply pipeline (1004), and a junction point between the first water supply pipeline (12) and the second water supply pipeline (1004) is located downstream of the water supply pump (1005); and an overflow valve (25) is arranged on the second water supply pipeline (1004).

6. The CCDAF process system according to claim 1, wherein the reciprocating moving device (13) comprises a guide rail (1301) mounted above the separation zone (104), a moving trolley (1302) is arranged on the guide rail (1301), and limit switches (1303) are arranged at two ends of the guide rail (1301).

7. The CCDAF process system according to claim 6, wherein the skimmer plate device (14) comprises a telescopic drive member (1401), the telescopic drive member (1401) is arranged on the moving trolley (1302), and a movable end of the telescopic drive member (1401) is connected to a skimmer plate (1402).

8. The CCDAF process system according to claim 7, wherein the telescopic drive member (1401) is an air cylinder.
